(19) United States
(12) Patent Application Publication
(10) Pub. No.: US 2008/0121357 A1
(43) Pub. Date: May 29, 2008

(54) Method And Apparatus For Fiberizing Particularly Paper And/Or Paperboard Based Materials

(76) Inventor: Jouko Kiviaho, Kovelahti (FI)

Correspondence Address: VENABLE LLP, P.O. BOX 34385, WASHINGTON, DC, 20043-9998, US

(21) Appl. No.: 10/573,355

(22) PCT Filed: Aug. 25, 2004
(86) PCT No.: PCT/FI04/00496

§ 371 Date: Mar. 24, 2006

(30) Foreign Application Priority Data
Sep. 25, 2003 (FI) 20031378

(51) Int. Cl. D21B 1/10; B02C 13/08; B02C 18/06

(52) U.S. Cl. 162/26; 162/261; 241/28; 241/292.1

(57) ABSTRACT

A method for fiberizing material and for feeding fiberized material to a further process. Fiberization is performed with a pulper, which includes a primary space for processing the material to be fiberized with a knife assembly rotating on a driving shaft. The material to be processed is forced, in order to fiberize the material, by rotary motion of the knife through a screen assembly, into a secondary space, for supplying the fiberized material further through an expulsion opening of the pulper to further processing. The knife assembly includes a primary knife unit for final preparation of a material to be fed into the pulper, and a secondary knife unit for fiberizing the material to be processed by forcing it to pass first through the secondary knife unit, and through a screen assembly, spaced from the knife assembly by a clearance. An apparatus can apply the method.

The invention relates to a method for fiberizing particularly paper and/or paperboard based material, for feeding a fiberized material, such as pulp wool, wood fiber or the like, subsequently to a further process, such as its application site, intermediate storage, shipping and/or the like. Fiberization is performed by means of a pulper, which is provided with a primary space for processing the material to be fiberized with a knife assembly included therein and rotating on a driving shaft, the material to be processed being forced, in order to fiberize the same, in response to its rotary motion through a screen assembly associated with, such as surrounding the knife assembly, into a secondary space present in the pulper, for supplying the fiberized material further through an expulsion opening of the pulper to further processing.

Particularly for building purposes, it is currently possible to replace conventional glass or rock wools with environmentally more friendly pulp wool, also called e.g. wood fiber. This type of pulp wool, which is generally applied by blowing, is manufactured e.g. from comminuted waste paper or paperboard by fiberization, which is traditionally performed e.g. by means of a so-called hammer mill. The hardware needed for such processing is extremely massive, which is why investment costs involved in such traditional processes are extremely high and require major throughputs for ensuring a sufficient viability. On the other hand, the use of a so-called hammer mill involves such a drawback that it must be accompanied by a separate fan or exhauster for enabling the delivery of a hammer-mill fiberized material to further processing. Another problem in such hardware solutions is a powerful development of dust, which is due to intermediate storage demands in major process entities, e.g. for managing and running a comprehensive process in consistency with the operating capacity of a pulper.

On the other hand, Patent publications U.S. Pat. No. 1,934,180, U.S. Pat. No. 4,919,340, and U.S. Pat. No. 5,188,298 disclose the utilization in the above-described purpose of a pulper, which has a primary space for processing a material to be fiberized with a knife assembly present therein and rotating on a driving shaft, the material to be processed being forced, in order to fiberize the same, in response to its rotary motion through a screen assembly associated with, such as surrounding the knife assembly, into a secondary space present in the pulper, for supplying the fiberized material further through an expulsion opening to its further processing. With regard to constructions described in the above-cited patents, it is in practice necessary to effect some sort of preprocessing of a material subject to fiberization, such as e.g. its comminution by means of a separate chopper or the like prior to fiberization in order to make the material to be supplied to a pulper sufficiently loose for the actual processing performed by the pulper's knife assembly. Otherwise, it is necessary to use a particularly high-performance pulper, and even then it is not possible to ensure optimal operating conditions and a sufficiently high-quality fiberization result because of the inhomogeneity of a pulp to be fiberized. On the other hand, the supply of a non-preprocessed, i.e. poorly comminuted material to a pulper of the discussed type results in the rapid wearing of knives included in its knife assembly, which in turn necessitates that service and maintenance procedures be implemented at very short time intervals.

Thus, an essential problem in currently available technology in terms of fiberization is the fact that the traditional hardware does not enable implementation especially a small-scale production firstly in a sufficiently simple fashion in terms of technology and secondly in an economically viable manner.

It is an object of the present invention to provide a decisive improvement with regard to the above problems and thereby to raise substantially the available prior art. In order to fulfil this objective, a method of the invention is principally characterized in that the knife assembly comprises a primary knife unit by which a material to be fed into the pulper is finally prepared for fiberization in a so-called integrated manner in conjunction with fiberization, and a secondary knife unit by which the material to be processed is fiberized by forcing it to pass first through the secondary knife unit, such as between vanes constituting such unit and disposed in overlying positions divergent relative to each other, and secondly through a screen assembly, such as a mesh, a grate, a perforated plate and/or the like, spaced from the knife assembly by a clearance.

Most important benefits offered by a method of the invention include the simplicity and reliability of its operation and hardware applicable therein. In addition, the inventive method enables production even at relatively small throughputs in an economically viable fashion as the preprocessing of a material to be fiberized is effected in a so-called integrated manner in conjunction with fiberization by means of a primary knife unit included in the pulper's knife assembly. By virtue of a pulper designed in accordance with the invention, it is possible to further simplify traditional hardware significantly since, as a result of the rotary motion of the knife assembly, the fiberized material will also be able to proceed to further processing, said operation being thus totally feasible without traditional exhaust or discharge fans. As the inventive method enables fiberization solely by means of a pulper of the invention, without e.g. a chopper to comminute raw stock prior to its fiberization, as required in traditional technology, the investment costs and power consumption of hardware needed for running the process remain minimal.

Preferred applications for a method of the invention are set forth in dependent claims directed thereto.

The invention relates also to an apparatus operating in consistency with the method, which is defined more precisely in the preamble of the independent claim directed thereto. Features principally characteristic for an apparatus of the invention are set forth in the characterizing clause of the respective claim.

Most important benefits offered by an apparatus of the invention include its simplicity and operating reliability as the preprocessing of a material to be fiberized is effected in a so-called integrated manner in conjunction with fiberization by means of a primary knife unit included in the pulper's knife assembly. By virtue of this, if compared to currently available respective solutions, it is feasible as an extremely small-scale compact entity or even as a so-called transportable version, erected e.g. on the platform or in the container of a truck. Thus, the inventive apparatus enables e.g. the production of pulp wool directly on site in which raw stock, such as waste paper or paperboard, has been collected. In terms of its simplicity, the apparatus is further based on the operating principle of a pulper which is preferable first in the regard that both the fiberization and the expulsion of fiberized material to further processing are feasible in response to a rotary motion of the knife assembly. On the other hand, also the introduction of a material to be fiberized and necessary additives, such as e.g. boric acid or borax, into the pulper is feasible in a similar manner, i.e. in response to a vacuum created by the knife assembly. Consequently, the inventive apparatus neither necessitates fans or exhausters included in traditional solutions for manipulating a material subject to fiberization/fiberized, nor separate preprocessing arrangements, such as a chopper or the like, for a material subject to fiberization.

Preferred embodiments for an apparatus of the invention are set forth in dependent claims directed thereto.

The invention will be described in detail in the following specification with reference made to the accompanying drawings, in which

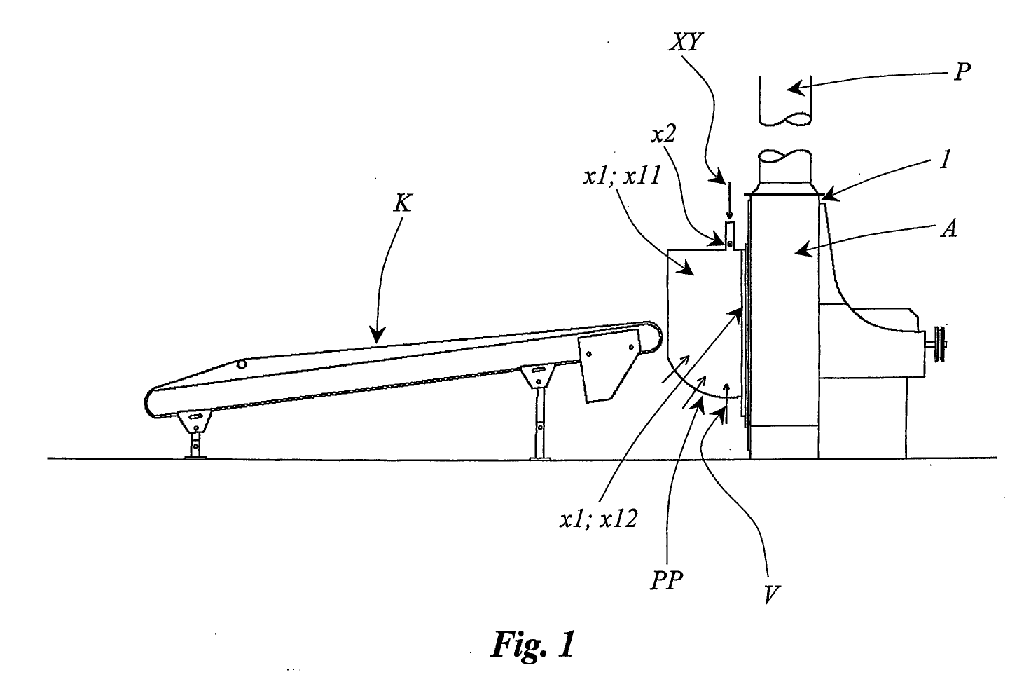

FIG. 1 shows one preferred fiberization process executed in keeping with a method of the invention,

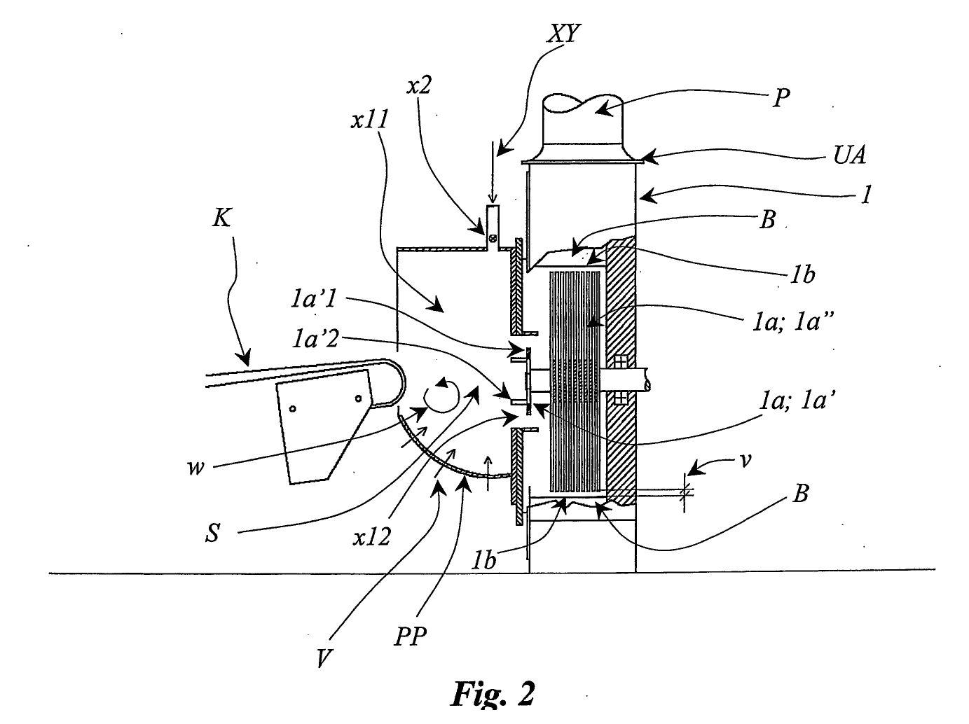

FIG. 2 shows the pulper of FIG. 1 in partial cross-section,

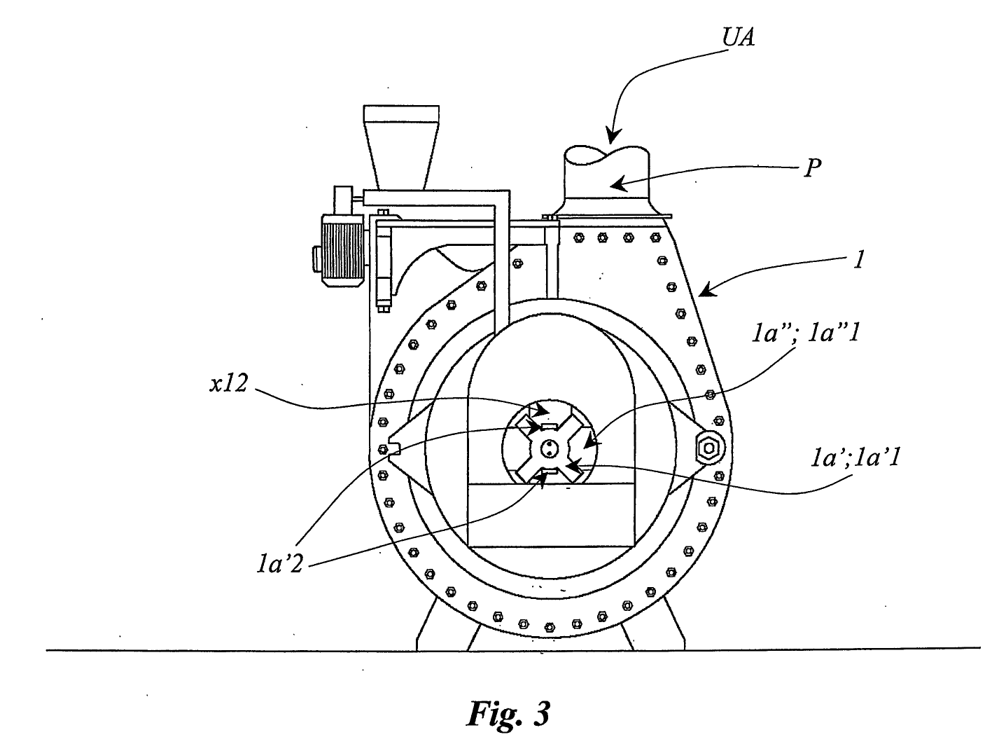

FIG. 3 shows the pulper of FIG. 1 in elevation viewed from its supply end, and

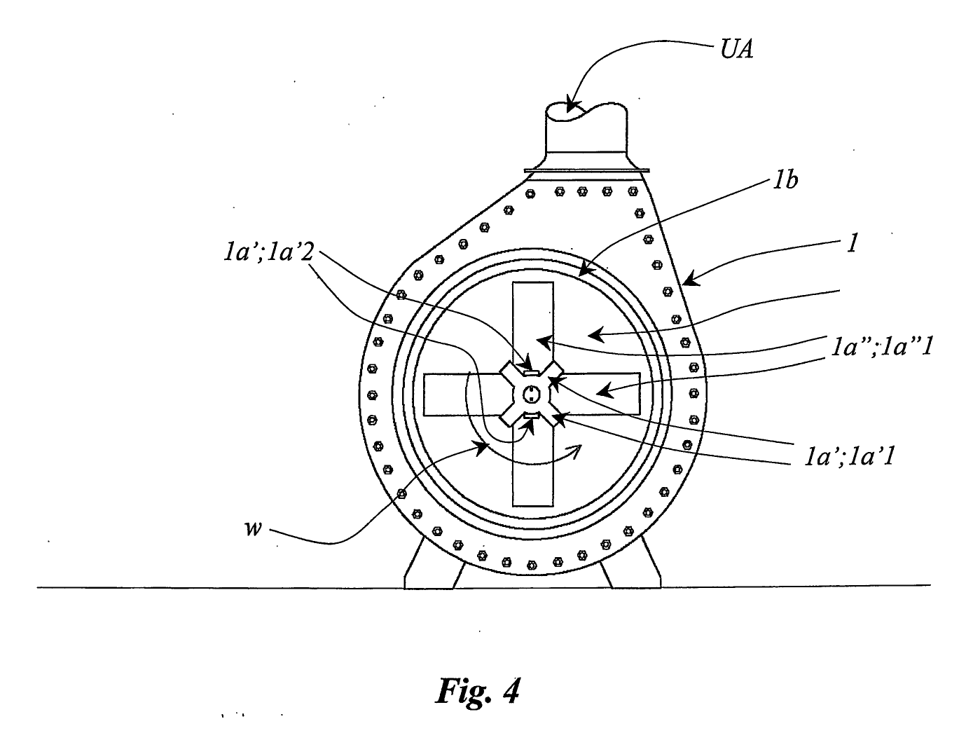

FIG. 4 shows a partially dismantled pulper in elevation similar to FIG. 3.

The invention relates to a method for fiberizing particularly paper and/or paperboard based material, for feeding a fiberized material, such as pulp wool, wood fiber or the like, subsequently to a further process, such as its application site, intermediate storage, shipping and/or the like. Fiberization is performed by means of a pulper 1, which is provided with a primary space A for processing the material to be fiberized with a knife assembly 1a included therein and rotating on a driving shaft s, the material to be processed being forced, in order to fiberize the same, in response to its rotary motion w through a screen assembly 1b associated with, such as surrounding the knife assembly 1a, into a secondary space B present in the pulper 1, for supplying the fiberized material further through an expulsion opening UA of the pulper 1 to further processing. The said knife assembly 1a comprises, as shown e.g. in FIGS. 2 and 4, a primary knife unit 1a′ by which a material to be fed into the pulper 1 is finally treated for fiberization in a so-called integrated manner in conjunction with fiberization, and a secondary knife unit 1a″ by which a material to be processed is fiberized by forcing it to pass first through the secondary knife unit 1a″, such as between vanes 1a″1 constituting the same and disposed in overlying positions divergent relative to each other, and secondly through the screen assembly 1b, such as a mesh, a grate, a perforated plate and/or the like, spaced from the secondary knife unit 1a″ by a clearance v.

In a preferred application, the material to be fiberized is preprocessed, such as worked up and comminuted, by first knife members 1a′1 included in the primary knife unit 1a′, which are disposed in a plane substantially coincident with the vanes 1a″1 of the secondary knife unit 1a″ for rotation together therewith, and by second knife members 1a′2 adapted to be integral with the first knife members 1a′1 and to protrude therefrom in a direction essentially away from the knife assembly 1a, such as to be perpendicular to the first knife members 1a′1.

In a further preferred application of the method, the fiberized material having migrated through the screen assembly 1b into the secondary space B is passed in response to the rotary motion w of the knife assembly 1a, such as in response to a centrifugal force and/or an overpressure, through the pulper's expulsion opening UA to further processing.

In yet another preferred method application, the fiberization is performed essentially as a dry process, the material to be fed into the pulper 1 and/or to be fiberized therein being supplied with one or several additives (XY), such as boric acid, borax and/or the like, particularly for enhancing the thermal/fire resistance properties, decay resistance properties and/or the like of a resulting product, such as pulp wool, wood fiber or the like to be used as thermal insulation. The material to be fiberized and/or the additive (XY) is fed to the fiberization process in a further preferred application, on a principle as depicted e.g. in FIG. 3, from a supply assembly x1 in connection with the pulper 1, such as from one or several supply pockets x11, supply openings x12 and/or the like, in response to an underpressure provided essentially by the rotary motion w of the knife assembly 1a.

The invention relates also to an apparatus suitable for utilizing the above-described method, having its knife assembly 1a, as illustrated e.g. in FIGS. 2-4, comprising a primary knife unit 1a′ for the final treatment of a material to be fed into a pulper 1 for fiberization in a so-called integrated manner in conjunction with fiberization, and a secondary knife unit 1a″ for fiberizing the material to be processed, the fiberization taking place in the pulper 1 by forcing it to pass first through the secondary knife unit 1a″ which, as depicted e.g. in FIGS. 2 and 4, consists of vanes 1a″1 disposed in overlying positions divergent (at a 90 [symbol] angle in FIG. 4) relative to each other, and secondly through a screen assembly 1b, such as a mesh, a grate, a perforated plate, and/or the like, spaced from the knife assembly 1a by a clearance v.

In a preferred embodiment of the apparatus, its primary knife unit 1a′ comprises a first knife member 1a′1, which is intended particularly for preprocessing, such as working up and comminuting the material to be fiberized and which is disposed in a plane substantially coincident with the vanes 1a″1 of the secondary knife unit for rotation together therewith, and a second knife member 1a′2 adapted to be integral with the first knife member 1a′1 and to protrude therefrom in a direction essentially away from the knife assembly 1a, such as to be perpendicular to the first knife members 1a′1.

In yet another preferred apparatus embodiment, the fiberized material having migrated through the screen assembly 1b into the secondary space B is adapted to pass through the pulper's expulsion opening UA to further processing essentially in response to the rotary motion w of the knife assembly 1a, such as in response to a centrifugal force and/or an overpressure, by virtue of which there is no need to employ separate fans or exhauster for this purpose.

In a still further embodiment of the apparatus, the pulper 1 has in connection therewith a supply assembly X1 for supplying the pulper 1 with a material to be fiberized and/or with one or several additives XY, such as boric acid, borax and/or the like, preferably as a dry matter on a principle as depicted e.g. in FIGS. 1 and 2, through a supply pocket x11 arranged upstream thereof and a supply opening x12 present in the pulper's cover element and further in response to an underpressure preferably provided by the knife assembly 1a and the rotary motion w, particularly for enhancing the thermal/fire resistance properties, decay resistance properties and/or the like of a resulting product, such as pulp wool, wood fiber or the like to be used as thermal insulation. Therefore, the supply pocket x11 has its bottom pp made permeable to air, such as a perforated structure, a grate structure or the like, which enables providing of an air flow V to work up a material to be fed into the pulper 1 in response to a suction created by the knife assembly 1a.

In yet another preferred embodiment, at least the primary knife unit's 1a′ first knife members and/or the secondary knife unit's 1a″ knives are designed, as shown e.g. in FIG. 4, in the form of elongated and radially disposed vanes 1a′1, 1a″1, having a thickness of 5-20 mm, preferably e.g. 10 mm. Respectively, the knife assembly 1a has a rotation speed w within the range of 1500-5000 revolutions per minute, in the most preferred case about 3000 revolutions per minute. Furthermore, the clearance v between the secondary knife unit 1a′ and the screen assembly 1b is within the range of 10-50 mm, preferably e.g. about 20 mm, and the screen assembly 1b has a screen capacity within the range of 30-50%, preferably about 40%.

In particular reference to the overall side view depicted in FIG. 1, especially a conveyor K, which is used for supplying the pulper 1 with a material to be fiberized, may comprise e.g. an open-structure belt or flight conveyor or else e.g. closed screw solutions or the like. Respectively, the additive, such as borax, which is used whenever necessary, may have its consistent material flow ensured by fitting its supply system with an agitator X2 driven e.g. by a small electric motor, which breaks eventual lumps and at the same time lets out a required amount of material. In this context, it is also possible to employ other conventional block feeder systems.

The first and second knife members 1a′1 and 1a′2 of a primary knife unit placed upstream of the secondary knives 1a″ included in the knife assembly 1a are particularly intended for chopping and working up a material on its way to the pulper 1 prior to its migration to the actual fiberization process. On the other hand, the material to be processed in the fiberization process is first of all defiberized to a certain degree by being forced to travel through gaps existing between the vanes 1a″1 included in the secondary knife assembly 1a″. For its main part, however, the fiberization takes place at an outer rim as the rotating vanes 1a″1 squeeze material out through the screen assembly 1b. After passing through the screen assembly, the material turned-to-pulp wool is carried on by a centrifugal force e.g. into a shipping container along a pipe P connected to the pulper's 1 expulsion opening UA. In the embodiment of FIG. 4, the first knife member has its vanes 1a′1 preferably at an angle of 45 [symbol] relative to the secondary knife unit's vanes 1a″1.

It is obvious that the invention is not limited to the applications illustrated or described above as it is apt to even considerable modifications within the basic inventive concept. First of all, the material manufactured by a method of the invention is feasible to be utilized not only for straightforward insulation purposes but also e.g. as a filler in other, such as building applications, e.g. in asphalt-laying operations, whereby the additive supplies may be omitted completely or else be substantially different from what was described previously. Hence, it is first of all self-evident that the inventive pulper can be outfitted more abundantly than what was described, both in terms of various materials to be fed therein and likewise in terms of safety at work, in which context, depending on the operating environment, it may be necessary to provide the pulper's exposed openings with proper safety devices or systems. Because the fiberization performed according to the invention is largely effected with a mechanical force action of the knife assembly, heat production may be quite abundant in places. Thus, it is naturally obvious that the inventive pulper is feasible to be outfitted e.g. with a cooling-water or cooling-air circulation or the like within its housing or knife assembly included therein. Moreover, it naturally feasible to secure the primary knife unit's first and/or second knife member in positions adjustable e.g. on a quick-release principle relative to each other and/or the secondary knife unit's vanes. On the other hand, it is also feasible to outfit both the primary knife unit and the secondary knife unit with a number of vanes/knives exceeding that illustrated in the attached drawings.

1. A method for fiberizing particularly paper and/or paperboard based material, for feeding fiberized material, such as pulp wool, wood fiber or the like, subsequently to a further process, such as its application site, intermediate storage, shipping and/or the like, the fiberization being performed by means of a pulper, which is provided with a primary space for processing the material to be fiberized with a knife assembly included therein and rotating around a rotation axis, wherein by the action of its rotation the material to be processed is preprocessed for fiberization by means of a primary knife unit, belonging to the knife assembly, whereafter it is being fiberized by means of a secondary knife unit, belonging to the knife assembly, and by leading it subsequently through a screen assembly associated with, such as surrounding the knife assembly, into a secondary space present in the pulper, for supplying the fiberized material further through an expulsion opening of the pulper to further processing, wherein the material to be fiberized is preprocessed by means of a primary knife unit, which has at least two members and/or is placed in a supply opening in a way that it is able to preprocess essentially all of the material to be fed into the pulper, whereafter the material is being finally fiberized by forcing it to pass between vanes, included in the secondary knife unit and disposed in overlying positions divergent relative to each other, the thickness of the vanes being between 5-20 mm.

2. The method according to claim 1, wherein the material to be fiberized is preprocessed by a primary knife unit which has at least two members, whereby first knife members included in the primary knife unit are disposed in a plane substantially coincident with the vanes of the secondary knife unit for rotation together therewith, and second knife members are adapted to be integral with the first knife members and to protrude therefrom in a direction essentially away from the knife assembly.

3. The method according to claim 1, wherein the fiberization is performed essentially as a dry process, wherein the material to be fed into the pulper and/or to be fiberized therein is supplied with one or several additives, such as boric acid, borax and/or the like, particularly for enhancing the thermal/fire resistance properties, decay resistance properties and/or the like of a resulting product, such as pulp wool, wood fiber or the like to be used as thermal insulation.

4. The method according to claim 1, wherein the material to be fiberized and/or the additive is fed to the fiberization process from a supply assembly in connection with the pulper, such as from one or several supply pockets, supply openings and/or the like, in response to an underpressure provided essentially by the rotary motion of the knife assembly.

5. An apparatus for fiberizing particularly paper and/or paperboard based material, for feeding fiberized material, such as pulp wool, wood fiber or the like, subsequently to a further process, such as its application site, intermediate storage, shipping and/or the like, said apparatus comprising a pulper, which is provided with a primary space and a knife assembly included therein and rotating around a rotation axis, which comprises a primary knife unit for preprocessing of the material to be fed into the pulper for fiberization and a secondary knife unit, by which the material to be processed is fiberized by forcing it by the action of the knife assembly's rotation through a screen assembly associated with, such as surrounding the knife assembly, into a secondary space present in the pulper, for supplying the fiberized material further through an expulsion opening of the pulper to further processing, wherein a primary knife unit included in the knife assembly is adapted to consist of at least two members and/or to be placed in a supply opening in a way that it is able to preprocess essentially all of the material to be fed into the pulper, and that a secondary knife unit consists of vanes, disposed in overlying positions divergent relative to each other and the thickness of which being between 5-20 mm.

6. The apparatus according to claim 5, wherein first knife members of the primary knife unit, consisting of at least two members, are disposed in a plane substantially coincident with the vanes of the secondary knife unit for rotation together therewith, and second knife members are adapted to be integral with the first knife members and to protrude therefrom in a direction essentially away from the knife assembly.

7. The apparatus according to claim 5, wherein the second knife members of the primary knife unit are adapted to be perpendicular to the first knife members.

8. The apparatus according to claim 5, wherein the pulper has in connection therewith a supply assembly for supplying the pulper with a material to be fiberized and/or with one or several additives, such as boric acid, borax and/or the like, particularly for enhancing the thermal/fire resistance properties, decay resistance properties and/or the like of a resulting product, such as pulp wool, wood fiber or the like to be used as thermal insulation, from one or several supply pockets, supply openings and/or the like, in response to an underpressure provided essentially by the rotary motion of the knife assembly.

9. The apparatus according to claim 5, wherein at least the primary knife unit's first knife members and/or second knife members are designed in the form of elongated and radially disposed vanes, having a thickness of 5-20 mm, most preferably 10 mm.

10. The apparatus according to claim 5, wherein the clearance between the secondary knife unit and the screen assembly is within the range of 10-50 mm, most preferably 20 mm, and/or that the screen assembly has a screen capacity within the range of 30-50%, most preferably 40%.
